(19) United States
(12) Patent Application Publication
(10) Pub. No.: US 2026/0204465 A1
(43) Pub. Date: Jul. 16, 2026

(54) TECHNIQUES FOR MITIGATING OVERCURRENTS IN HIGH TEMPERATURE SUPERCONDUCTOR MAGNETS AND RELATED SYSTEMS AND METHODS

(71) Applicants: Massachusetts Institute of Technology, Cambridge, MA (US); Commonwealth Fusion Systems LLC, Devens, MA (US)

(72) Inventors: Alexey RADOVINSKY, Cambridge, MA (US); Nicholas J. Kelton, Somerville, MA (US); Valeria Riccardo, Monmouth Junction, NJ (US); Akhdiyor Israilovich Sattarov, College Station, TX (US)

(73) Assignees: Massachusetts Institute of Technology, Cambridge, MA (US); Commonwealth Fusion System LLC, Devens, MA (US)

(21) Appl. No.: 19/133,916

(22) PCT Filed: Dec. 13, 2023
(86) PCT No.: PCT/US2023/083812

§ 371 Date: May 29, 2025

Related U.S. Application Data
(60) Provisional application No. 63/432,548, filed on Dec. 14, 2022.

(51) Int. Cl. H01F 6/02; H01F 6/06

(52) U.S. Cl. CPC H01F 6/02; H01F 6/06

(57) ABSTRACT

Techniques are providing for mitigating overcurrents in superconducting magnets by adding a closed loop of superconductor to the magnet that acts as an electromagnetic shield. A time-varying external magnetic field may induce a current in the closed loop, thereby generating a magnetic field that opposes the external magnetic field, and reducing the amount of current induced by the external magnetic field in the primary current-carrying superconductor of the magnet. As a result, the effect of overcurrents can be reduced or removed.

### FIELD OF THE INVENTION

This application relates to high-temperature superconductor (HTS) magnets and, more particularly, to high-temperature superconductor magnets comprising an electromagnetic shield to mitigate overcurrents.

### BACKGROUND

Superconductors are materials that have no electrical resistance to current (are “superconducting”) below some critical temperature. For many superconductors, the critical temperature is below 30 K, such that operation of these materials in a superconducting state requires significant cooling, such as with liquid helium or supercritical helium.

High-field magnets are often constructed from superconductors due to the capability of superconductors to carry a high current without resistance. Such magnets may, for instance, carry currents greater than 5 kA.

### SUMMARY

According to some aspects, a high temperature superconductor (HTS) magnet is provided comprising a housing comprising a coil comprising HTS material, and a closed loop of HTS material not galvanically connected to the coil.

According to some aspects, a high temperature superconductor (HTS) magnet is provided comprising a stack of pancakes each comprising a coil comprising HTS material, and a terminal pancake at an end of the stack of pancakes comprising a closed loop of HTS material.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A shows a cross sectional view of a magnet assembly, according to some embodiments;

FIG. 1B depicts an enlarged portion of the cross-sectional view of FIG. 1A, according to some embodiments:

FIG. 2A illustrates a cross-sectional view of a magnet assembly that includes a passive loop, according to some embodiments;

FIG. 2B depicts an illustrative tie plate that includes a groove for a passive loop, according to some embodiments;

FIG. 3A depicts a magnet assembly that includes a closed loop of superconductor galvanically connected to the primary current-carrying superconductor of the magnet, according to some embodiments;

FIG. 3B depicts a groove of a conductive joint, according to some embodiments;

FIGS. 3C-3D depict a closed loop of superconductor material that may be arranged in the groove of the conductive joint of FIG. 3B, according to some embodiments;

FIGS. 4A-4B depict illustrative designs for a passive loop of superconductor material, according to some embodiments;

FIGS. 5A-5B show different cross-sections of an illustrative stack of plates in a superconducting magnet, according to some embodiments;

FIGS. 6A-6B are perspective views of opposing surfaces of an illustrative individual plate of a type which may be included in a stack of plates in a superconducting magnet, according to some embodiments;

FIGS. 6C-6D are perspective views of opposing surfaces of an illustrative individual plate of a type which may be included in a stack of plates in a superconducting magnet, according to some embodiments;

FIGS. 7A-7C depict alternative passive loop geometries for magnet coils, according to some embodiments;

FIG. 8 is a three-dimensional graphic of a fusion power plant with a cutaway portion illustrating various components of the power plant, according to some embodiments; and

FIG. 9 depicts a cross-sectional view of the layers of an illustrative coated-conductor HTS tape, according to some embodiments.

### DETAILED DESCRIPTION

A high-field (e.g., generated by a current greater than 5 kA) superconducting magnet often comprises multiple electrically insulated cable turns grouped in a multi-layer arrangement. When the superconducting material is cold enough to be below its critical temperature (the temperature below which the electrical resistivity of the material drops to zero), driving the magnet allows current to pass through the superconducting path without losses. In general, a superconducting magnet can carry a relatively high current density (e.g., a high amount of current per unit volume or per unit cross-sectional area of superconducting material) while also producing a high magnetic field.

Some superconducting magnets may operate within an environment in which there is an external magnetic field (i.e., external to the magnet). If the external field is time varying, eddy currents may be induced within the superconducting magnet, which may in turn generate currents in excess of the transport current for which the magnet is designed. These ‘overcurrents’ may cause some of the superconductor to exceed its critical current limit, which in turn may cause the superconductor to exceed its critical temperature and act as a normal conductor, causing a quench of the magnet.

For instance, superconductor magnets within a tokamak may be operated in a pulsed mode to limit resistive heating of conventional conductors within the magnets. In this mode, the current directed through the magnet is ramped up, then ramped down (forming a ‘pulse’). After a waiting period, another pulse of ramping up and ramping down is performed, etc. This process causes a magnet to produce a time-varying magnetic field that can induce eddy currents in other magnets in the tokamak, thereby potentially producing an overcurrent.

The inventors have recognized and appreciated techniques for mitigating overcurrents in superconducting magnets by adding a closed loop of superconductor to the magnet, which acts as an electromagnetic shield. A time-varying external magnetic field may induce a current in the closed loop, thereby generating a magnetic field that opposes the external magnetic field, and reducing the amount of current induced by the external magnetic field in the primary current-carrying superconductor of the magnet. The closed loop may provide a low resistance path for induced current to follow without affecting the transport current of the magnet. As a result, overcurrents in a superconducting magnet may be reduced in magnitude, or possibly even mitigated entirely.

According to some embodiments, the closed loop of superconductor may not be galvanically connected to the primary current-carrying superconductor of the magnet. In some cases, a closed loop of superconductor that is not galvanically connected to other superconductors in the magnet (also referred to below as a “passive loop”) may be arranged within the housing of the magnet, and arranged proximate to a coil of the magnet. For example, a magnet may include a stack of coils (e.g., in a ‘pancake’ structure as a ‘stack of pancakes’), and a passive loop may be arranged adjacent to one end of the stack of coils.

According to some embodiments, the closed loop of superconductor may be galvanically connected to the primary current-carrying superconductor of the magnet. In some cases, additional superconductor may be added within existing current paths within a superconducting magnet, though with a closed loop structure. For example, a magnet that includes an electrically conductive “joint” (i.e., a conventional conductor that galvanically connects regions of superconductor within the magnet), may include a closed loop of superconductor that is galvanically connected to the joint. Current induced in this closed loop of superconductor may not significantly contribute to the transport current of the magnet.

Following below are more detailed descriptions of various concepts related to, and embodiments of, techniques for mitigating overcurrents in superconducting magnets. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein. In particular, the techniques are illustrated below with respect to particular magnet designs. It may be appreciated that the techniques may be applied to other magnet designs as well, and that the designs described herein are provided for purposes of explanation and illustration.

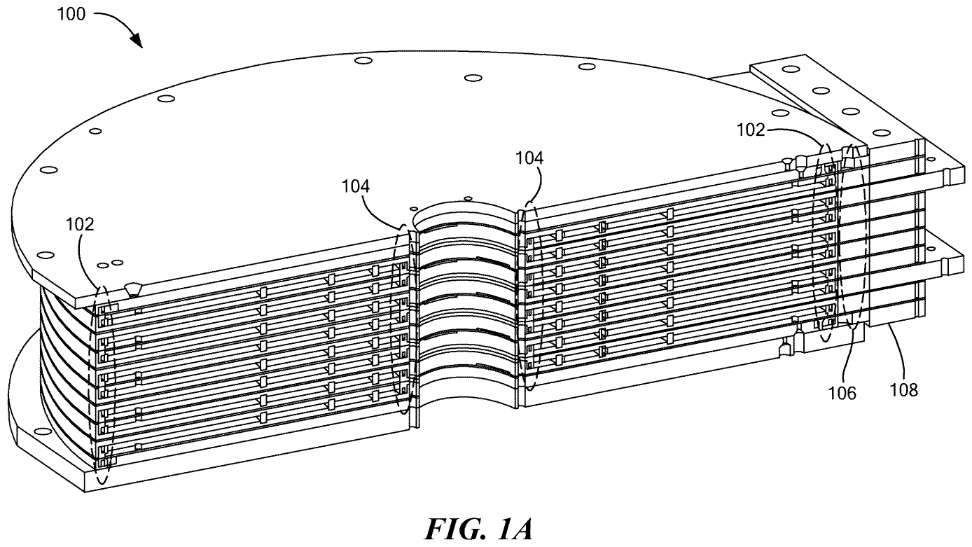

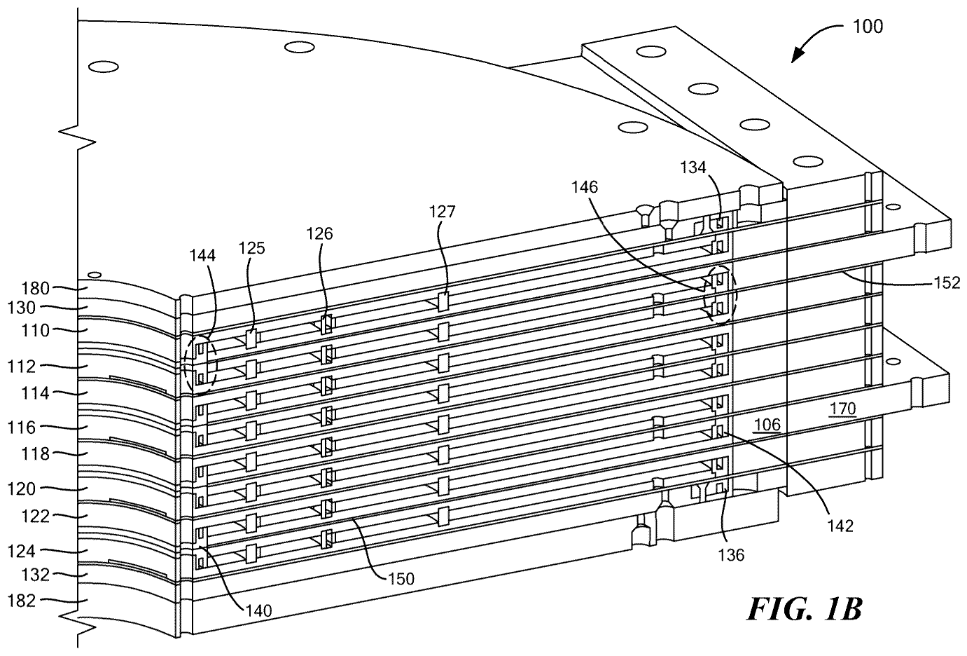

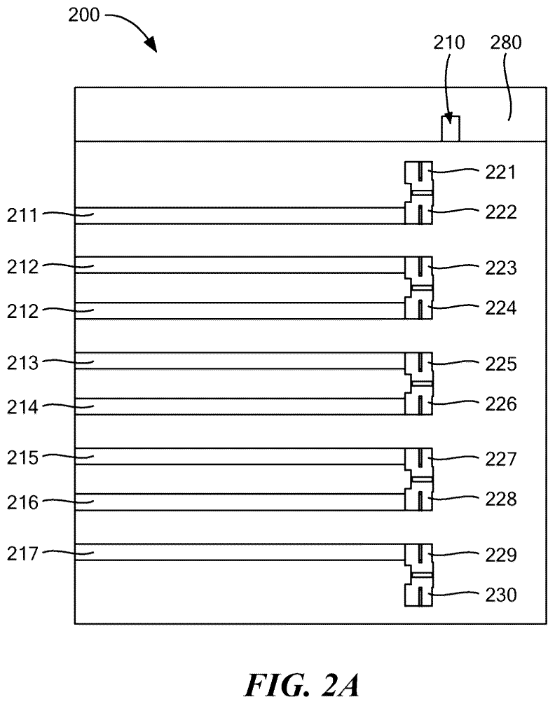

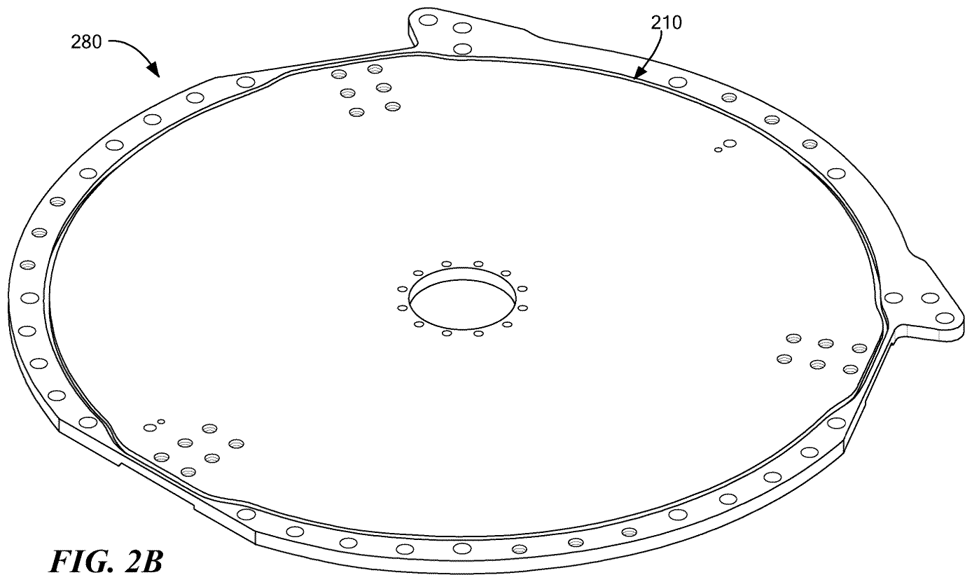

FIG. 1A shows a cross sectional view of a magnet assembly 100, and FIG. 1B shows an enlarged portion of the cross-sectional view, according to some embodiments of a high temperature superconductor (HTS) magnet. The illustrated magnet assembly 100 has a magnet design in which superconductor material (e.g., HTS tapes) is arranged within a stack of plates, also referred to herein as “pancakes”. The general design of this type of magnet is described with respect to FIGS. 1A-1B, and examples of ways in which this magnet may be shielded by adding a closed loop of superconductor are described further below with respect to FIGS. 2A-2B, 3A-3D and 4A-4B.

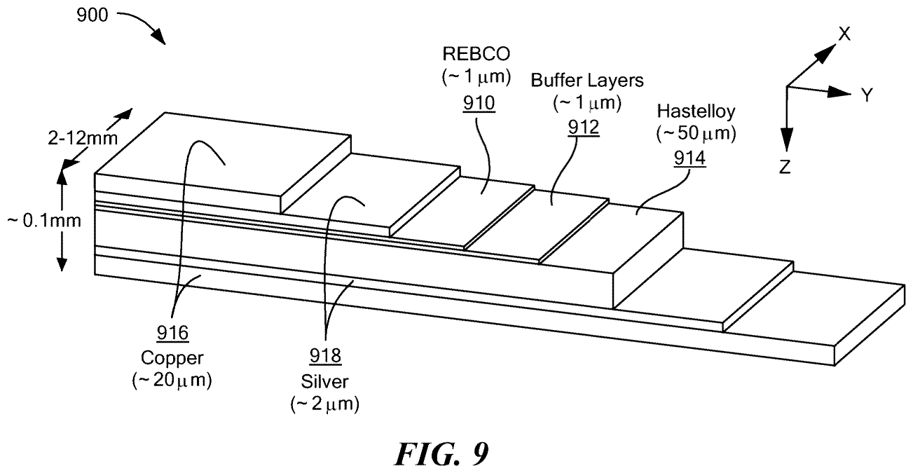

In some cases, the superconductor material may include HTS tape. As used herein, “HTS tape” refers to a long, flat element that comprises a layer of HTS material (e.g., polycrystalline HTS) in addition to other layers. In some embodiments, HTS tape also may refer to any structure that includes a layer of an HTS, such as a rare-earth cuprate HTS (e.g., REBCO), and which may also contain one or more other layers such as one or more buffer layers, stabilizing layers, substrates, overlay layers and/or cladding layers, such as HTS tape 900 shown in FIG. 9.

For purposes of illustration, FIG. 9 depicts a cross-sectional view of the layers of an illustrative coated-conductor HTS tape, according to some embodiments. The below description may, in some embodiments, apply to the HTS tapes described herein as being arranged within a magnet or magnet assembly. FIG. 9 is an example of an HTS tape 900 that is fabricated as a coated conductor, wherein the HTS layer 910 is a layer of REBCO, which is an acronym for “rare-earth barium copper oxide.” As used herein, in at least some cases “REBCO” may be used to refer more generally to any rare-earth cuprate HTS. As such, unless expressly stated otherwise, barium may be present in REBCO, but is not required to be present. Nonetheless, in the example of FIG. 9 the REBCO layer is provided as one example of an HTS layer and is not intended to limit the illustrated structure to the use of any particular HTS.

In the example of FIG. 9, the illustrative HTS tape 900 also includes a buffer layer 912, a Hastelloy® layer 914, and copper and silver layers 916 and 918, respectively, which are arranged both above and below the REBCO layer. The copper layer is sometimes referred to as a “stabilizer” layer. Illustrative dimensions of the tape are shown in FIG. 9, with the tape having a width (size in the X direction) of around 2 -12 mm and a thickness (size in the Z direction) of around 0.1 mm.

In some embodiments, an HTS tape may have an aspect ratio (being the ratio of the tape's width to its thickness) that is greater than or equal to 10, 20, 40, 60, 80, 100, 120 or 150. In some embodiments, the HTS tape may have an aspect ratio that is less than or equal to 150, 120, 100, 80, 60, 40, 20 or 10. Any suitable combinations of the above-referenced ranges are also possible (e.g., an aspect ratio of greater than or equal to 60 and less than or equal to 100).

In some embodiments, an HTS tape may have a thickness greater than or equal to 0.005 mm, 0.01 mm, 0.05 mm, 0.1 mm, 0.15 mm, or 0.2 mm. In some embodiments, the HTS tape may have a thickness less than or equal to 0.5 mm, 0.2 mm, 0.15 mm, 0.1 mm, 0.05 mm, or 0.01 mm. Any suitable combinations of the above-referenced ranges are also possible (e.g., a thickness of greater than or equal to 0.01 mm (or about 0.01 mm) and less than or equal to 0.1 mm (or about 0.1 mm)).

In some embodiments, a superconducting magnet, such as that shown in FIGS. 1A-1B, may comprise an HTS tape that is wound around a winding axis such that the x-axis of the tape as shown in FIG. 9 is aligned parallel to the winding axis. In the case of a non-insulated magnet design, for instance, HTS tapes may therefore contact the face (the x-y plane in FIG. 9) of adjacent HTS tapes. In some embodiments, the superconducting magnet may comprise windings of a stack of HTS tapes along with a non-superconducting electrically conductive material, such as steel or copper.

In the example of FIGS. 1A-1B, the magnet assembly 100 comprises a stack of pancakes that are each formed from an upper structural plate and a lower structural plate. Superconductor material (e.g., HTS tapes as described above) is arranged between the plates in a coil, with the material being wound within the annular region between the plates (e.g., wound from the center to the perimeter). Partitions, described further below, are arranged between the upper and lower structural plates to provide mechanical strength, and include an opening to allow the superconductor material to pass through the partition. Electrically conductive joints 102 and 104 are arranged at the outer and inner ends of the plates, respectively, to conduct current from the superconductor material within one pancake to the superconductor material within neighboring pancakes. The direction of current flow may therefore be an inward spiral for one pancake, and an outward spiral for its neighboring pancakes (or the reverse thereof). The entire magnet assembly may be cooled via a coupling to a suitable cooling apparatus at terminal 108 to transfer or otherwise remove heat via thermal conduction. The cooling apparatus may be electrically insulated from the magnet assembly by a suitable electrical insulator 106 (e.g., a high-pressure fiberglass laminate).

In some embodiments, the mechanical structure that retains superconductor material (hereafter the “housing”) of each pancake may be formed of or comprise steel, or any other suitable structural, electrical conductor like an austenitic nickel-chrome alloy such as an INCONEL® alloy from Special Metals Corporation of New Hartford, New York or a nitrogen-strengthened austenitic stainless steel such as a NITRONIC® alloy from AK Steel of West Chester, Ohio.

Though the example of FIGS. 1A-1B depicts a particular, electrically non-insulated pancake design, it is appreciated that many of the features and manufacturing techniques disclosed herein are applicable to magnets formed by fully or partially insulated HTS tapes or tape stacks, and that a person having ordinary skill in the art would understand how to adapt the concepts, techniques, and structures taught herein to fully or partially insulated designs. For example, a magnet assembly need not include the same number of partitions in each pancake, and need not include pancakes at the same radii in each pancake, as shown in the example of FIGS. 1A-1B.

FIG. 1B depicts an enlarged portion of the cross-sectional view of FIG. 1A. In the example of FIG. 1B, the magnet assembly 100 includes two types of pancakes, referred to herein as “regular” pancakes and “terminal” pancakes. Regular pancakes 110, 112, 114, 116, 118, 120, 122, and 124 each may be formed from a pair of structural plates having structural partitions between them. These partitions define a plurality of channels for retaining one or more turns of HTS tape, or tape stack, which produce a magnetic field when an electrical current is applied, as described above. In some embodiments, at least part of one or more of these channels is arranged in a spiral path. (The HTS tape stack is not shown in FIGS. 1A-1B to provide more visual clarity to the structure of the pancakes themselves. That is, only the housings are shown.)

In the example of FIG. 1B, the pancake 110 comprises three partitions 125, 126, 127 from the inside diameter outward, and this partition design is replicated in the other regular pancakes of the stacked magnet assembly 100. The turns of the HTS stack form a continuous spiral in the channels of each pancake, electrically connecting its inside diameter (sometimes referred to herein as “ID”) to its outside diameter (sometimes referred to herein as “OD”). The partitions may be arranged within a slot (e.g., a circular slot) formed within the upper and lower structural plates; as shown in FIG. 1B, the partitions extend partially into the structural plates when shown in cross-section.

According to some embodiments, the HTS tape of at least one of the pancakes may comprise a rare-earth copper oxide, such as REBCO. It is appreciated that other superconducting materials may be used within the magnet assembly 100 for generating magnetic fields in accordance with embodiments of the concepts, techniques, and structures disclosed herein.

According to some embodiments, HTS tape and co-wound materials within magnet assembly 100 can be left free standing, tightly packed in the structure of the pancake so that one or more turns of the HTS tape stack in each of the channels substantially fill the volume of the channel. Co-wound materials refer to any materials that are not HTS and that are wound within the magnet assembly along with the HTS tape. Examples of co-wound materials include steel tape, copper tape, or a nickel alloy tape. Alternatively to leaving the HTS tape and co-wound material(s) free standing, the HTS tape of at least one of the pancakes can be soldered into at least one of the plurality of channels, and is soldered into the one or more conductive joints. It is appreciated that other methods may be used to secure a superconducting tape or tape stack within the magnet assembly 100 in accordance with embodiments of the concepts, techniques, and structures disclosed herein.

According to some embodiments, to increase quench stability due to small resistive heating in the conductive joints, and possible overstraining and/or overstressing the tape in conductive joints and channel-to-channel transitions through the partitions within each pancake, copper co-wind can be added in these vulnerable areas. To reduce quench-related temperature rise by inductively picked-up eddy current heating of copper fractions in joints, current leads, and channel-to-channel transitions, the HTS tape stack can be reinforced by adding in-line HTS tapes to provide more current-carrying capacity. Furthermore, to reduce possible kinking of the HTS tape stack in in joints, current leads, and channel-to-channel transitions, the HTS tape stack can be reinforced by steel tape co-wind. Additional co-wind may be added. For example, copper co-wind can be added to enhance normal zone propagation through the partition during a quench, or for other purposes.

According to some embodiments, each of the pancakes of magnet assembly 100 may include one or more electrically conductive joints (also referred to herein as “joints”) for electrically coupling the one or more turns of its HTS tape as part of an electrical circuit. More concretely, ring-shaped joints, embedded into the structural plates, may be located at the inside diameter and the outside diameter of each regular pancake, terminating the superconducting electrical path. These joints may comprise, or may consist of, copper and/or another electrically conductive material, and/or may comprise, or may consist of, superconducting material. Illustratively, regular pancake 122 has an inside diameter joint 140 and an outside diameter joint 142. The HTS tape stack spiral continues into grooves in these joints. In some embodiments, the spiral of HTS material within a joint is terminated after a plurality of complete 360-degree turns, while in other embodiments the grooves are terminated before or after one full turn. The HTS material within the joints may be arranged as an open spiral, in contrast to a closed loop of HTS material that may be arranged within a terminal pancake over part of a channel containing HTS tape, as described below.

According to some embodiments, inside diameter and outside diameter joints 140 and 142, respectively, may be embedded into the structural plates of each pancake so that they are flush with, or slightly extend above, the flat surface of the structural plates on its opposite sides. In particular, the joints may extend above the structural plates to provide adjacent space for cooling plates, as described below. In accordance with the modular design disclosed herein, the number of regular pancakes can be any number greater than or equal to one pancake, to produce a desired magnetic field.

In accordance with the example of FIGS. 1A and 1B, a plurality of identical regular pancakes may be stacked together with alternating axial orientation of the HTS tape-filled channels. This arrangement may provide a continuous electrical path between the exposed joints of the two outermost pancakes, via HTS tape spirals and mated ID-to-ID and OD-to-OD joints of all pancakes of the magnet assembly 100. In detail, a pattern of alternating housings may be repeated where one of the pancakes is electrically coupled by the joint on its outside diameter to a joint on the outside diameter of a second one of the pancakes, and the first one of the pancakes is electrically coupled by the joint on its inside diameter to a joint on the inside diameter of a third one of the pancakes. Illustratively, in FIG. 1B the outside diameter (OD) joint of the first pancake 112 and the outside diameter (OD) joint of the second pancake 114 are mated via the electrical coupling provided by joints 146, while the inside diameter (ID) joint of the first pancake 112 and the inside diameter (ID) joint of the third pancake 110 are mated via the electrical coupling provided by joints 144. To facilitate better electrical contact of pancake-to-pancake joints, during manufacture an electrically conductive (e.g., indium) gasket may be inserted between the respective mating surfaces of the joints of two adjacently stacked pancakes.

It may be noted that, in FIG. 1B, the coupling region that includes joints 146 also includes a portion of the cooling plate 152 inserted between the joints in the pancakes 112 and 114. In the illustrative magnet assembly of FIGS. 1A and 1B, the outer joints between the plates make contact only on one half of the pancake, with the other half having a cooling plate inserted between the pancakes. This difference is evident from comparing the regions comprising joints 102 on the left side of FIG. 1A, which shows the joints contacting one another, and the region on the right side of FIG. 1A, which shows joints 102 having the cooling plate inserted between them.

In the example of FIGS. 1A and 1B, the electrical path of the HTS tape winding is completed by two outermost, terminal pancakes 130 and 132. Terminal pancakes 130, 132 each present a solid structural plate with only one ring-shaped joint, located either at the ID or OD at the same radial position as in the regular pancakes with which they make electrical contact. In other words, each terminal pancake comprises an interior surface having a joint on either its outside diameter or its inside diameter that is electrically coupled to a joint of another (regular) pancake, and a parallel, exterior surface lacking a joint.

In the example of FIGS. 1A and 1B, both terminal pancakes 130, 132 have respective joints 134, 136 at the OD, but only on their interior surfaces. The ring-shaped joints 134, 136 of the terminal pancakes 130, 132 are continuously connected with electrically conductive plates, of the same conductor and extended radially outward, usually in the direction of HTS current leads which form external electrical connections to the HTS tape stack. The HTS tape stack starts inside the ring of the joint, makes a 360-degreed loop in the groove of the joint, and then joggles out into a groove in the extension plate. Thus, each of the pancakes (both regular and terminal) is electrically coupled by its one or more joints to the joints of either one or two neighboring pancakes, thereby forming an operating current path that includes the HTS tape in each of the pancakes.

According to some embodiments, although ID and OD joints are described above as executed in the shape of continuous circular rings, the joints may alternatively be configured as discrete plates, made as extensions from the respective pancakes and positioned with regard to the pancakes so that they mate in the assembly and can be pressed together and secured either individually, one joint at a time, or all together in the cold mass assembly, as described above.

According to some embodiments, since pancakes are independent from each other and are connected for electrical operation only at the joints, the shape of individual pancakes can be different, as long as joints of adjacent pancakes have mating surfaces. In general, the cold mass and the HTS winding can be shaped as a solenoid, as a “D-shape”, or as a racetrack (i.e., an oval or obround shape), or can have a different shape that is topologically compliant with any of these. Thus, at least two of the pancakes may have different sizes or different shapes. It is expected that a person having ordinary skill in the art may conceive of other sizes or shapes without deviating from the concepts and techniques disclosed herein.

According to some embodiments, the cold mass may be conduction cooled by thermally conductive (e.g., copper, aluminum, silver, gold, graphene, etc.) cooling plates inserted between the pancakes in the space not already filled by the joints. In the example of FIGS. 1A and 1B, copper cooling plates 150 are positioned between adjacent regular pancakes 122 and 124, and this design of alternating pancakes and cooling plates is repeated throughout the magnet assembly 100 as shown. In some embodiments, copper cooling plates may be electrically insulated to prevent electrical shorts between the pancakes. This insulation may be accomplished by coating each surface with a layer of electrical insulator, such as polytetrafluoroethylene (PTFE) or similar, and solidifying the insulator. It is appreciated that other coatings may be used.

Each of the copper cooling plates 150 may be thermally conductive, and may be arranged to pass from between the pancakes through a layer of electrical insulator to a terminal for thermally coupling the cooling plate to a cooling apparatus. In the example of FIGS. 1A and 1B, the copper cooling plates 150, 152 have terminals in thermal contact with a terminal 170 of the cooling apparatus. In this way, each of the pancakes is adjacent to either one or two of the cooling plates, allowing the pancake to be cooled to an operating temperature, and allowing the pancake to transfer heat produced in the pancake via thermal conduction to the cooling apparatus. Concretely, each terminal pancake is adjacent to one of the cooling plates, and each regular pancake is adjacent to two of the cooling plates.

To complete manufacture of the magnet assembly 100 shown in FIGS. 1A-1B, regular and terminal pancakes, having a number appropriate to operational requirements, may be stacked with insulated copper cooling plates as described above, and the stack of pancakes with intermediate cooling plates may be tied together by bolts at both its inside diameter and its outside diameter. In the example of FIGS. 1A-1B, the magnet assembly 100 incudes additional structural plates (also referred to a “tie plates”) 180, 182 at the top and bottom of the stack that are bolted to each other via tie bolts, and the stacked plates are instead (or additionally) pressed together by the tie plates 180, 182. At a later time, the magnet assembly 100 can be disassembled by removing the tie bolts and separating the individual pancakes. Afterward, the cold mass can be reassembled with more or fewer regular pancakes to achieve a different operating magnetic field, as needed.

FIG. 2A illustrates a cross-sectional view of a magnet assembly that includes a passive loop, according to some embodiments. In the example of the magnet 200 shown in FIG. 2A, which may be an implementation of the magnet assembly 100 shown in FIGS. 1A-1B, the pancake structures are not shown in favor of depicting the superconductor material and joint structures. In particular, at least part of one side of the pancakes is shown in cross-section, depicting superconductor coils 211-217 and joints 221-230 connecting the coils between the pancakes at the outer diameter. Inner diameter joints, akin to joints 140 and 144 shown in FIGS. 1A-1B and described above, may also be included in magnet 200 although they are not shown in FIG. 2A.

In the example of FIG. 2A, the tie plate 280 includes a groove 210 in which a passive loop of superconductor material may be arranged. The groove 210 may form a closed loop within the tie plate 280, which may be circular or approximately circular.

According to some embodiments, the passive loop of superconductor material may be soldered into the groove 210.

According to some embodiments, a closed loop of a stack of HTS tapes may be arranged within the groove 210. The stack of HTS tapes may be arranged so that one end of a portion of HTS tapes overlaps the other end of the portion of the HTS tapes, for instance. In some cases, multiple pieces of HTS tapes may be arranged into a closed loop and soldered into the groove. For example, pieces of HTS tapes left over from cutting longer tapes may be utilized to form the passive loop. In some embodiments, the closed loop may be formed from a stack of 60-80 HTS tapes, such as around 70 HTS tapes. The number of tapes in this stack may be greater than a number of HTS tapes in a stack within the conductive joint of the terminal pancake 221.

FIG. 2B depicts an illustrative tie plate that includes a groove for a passive loop, according to some embodiments. In the example of FIG. 2B, an illustrative implementation of the tie plate 280 shown in FIG. 2A and described above is depicted, with a groove 210 formed in its surface. The groove may be arranged in the lower surface of the tie plate (that is, the surface closest to the primary transport HTS in the magnet), or may be arranged in the opposing surface.

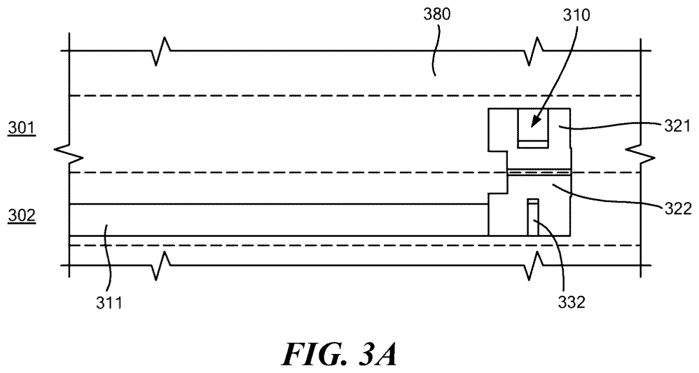

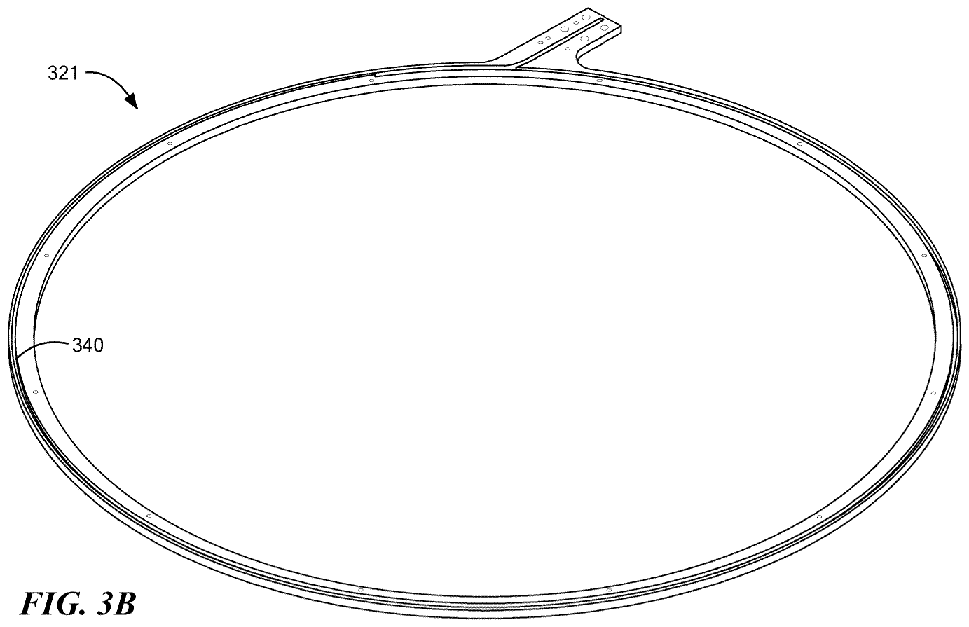

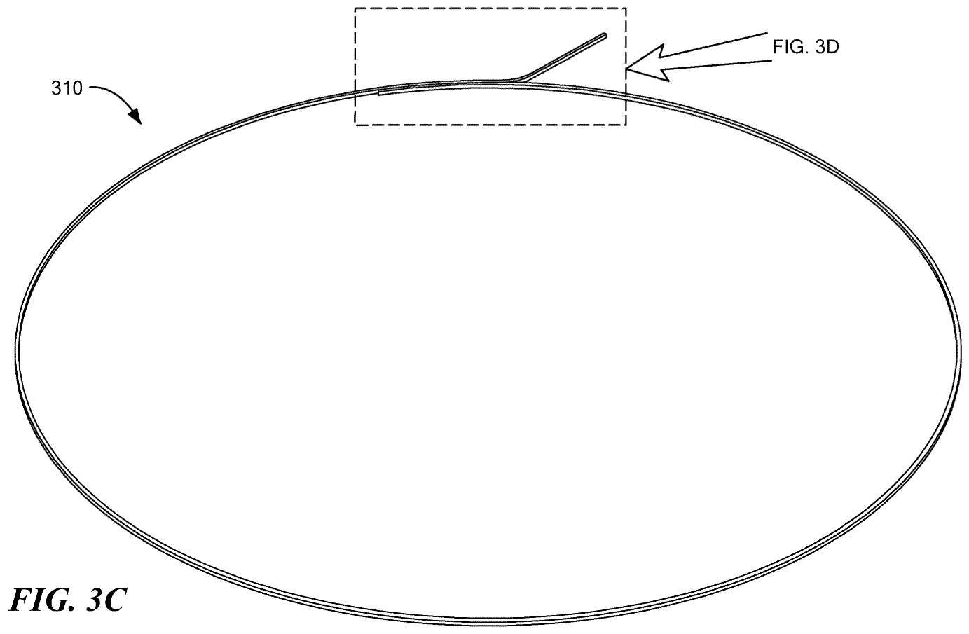

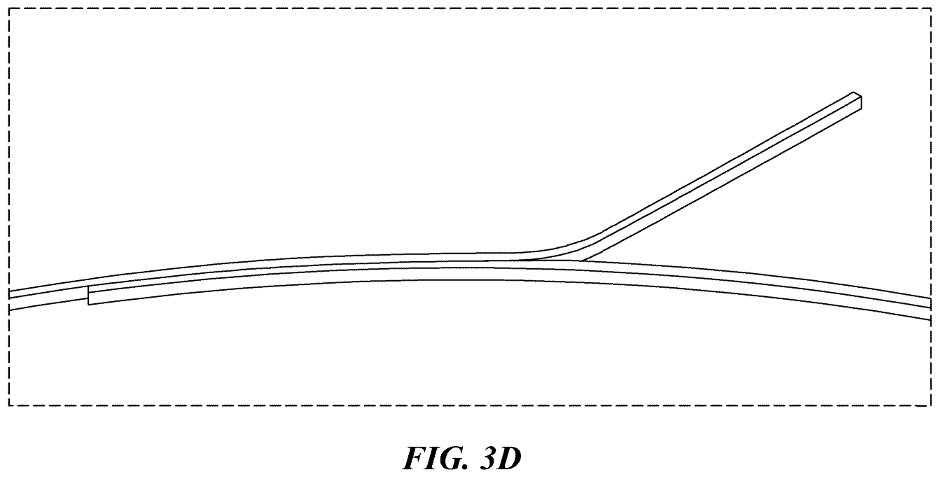

FIGS. 3A-3D depict a magnet assembly that includes a closed loop of superconductor galvanically connected to the primary current-carrying superconductor of the magnet, according to some embodiments. As described above, additional superconductor may be added within existing current paths within a superconducting magnet, though with a closed loop structure, such that current induced within the loop does not significantly contribute to the transport current of the magnet. In the example of FIG. 3A, a portion of superconductor material 311 within a pancake 302 is shown (the structural parts of the pancakes are omitted in FIG. 3A), with an outer conductive joint 322. A terminal pancake 301 is also shown, with an outer conductive joint 321. A tie plate 380 is arranged over the pancakes 301 and 302.

As described above, a joint of a magnet assembly may include superconductor material (e.g., the HTS tape spiral within a pancake may continue into a groove within the joint). Such a region of superconductor material is shown in the example of FIG. 3A as region 332, for instance, and is also shown in FIG. 2A and FIGs. 1A-1B for various pancake joints. In the example of FIG. 3A, a closed loop of superconductor material 310 is arranged within outer conductive joint 321. While the terminal pancake 301 may in some cases conventionally include superconductor material in this location, in the example of FIG. 3A, the superconductor material 310 is arranged as a closed loop, whereas conventionally the superconductor material within the joint would be arranged as a coil (e.g., that connects to current leads).

According to some embodiments, the superconductor material 310 within outer conductive joint 321 may comprise a stack of HTS tapes. In some cases, the number of tapes in the stack of HTS tapes in the outer conductive joint 321 may be larger than the number of tapes in the stack of tapes in the outer conductive joint 322. In general, the joints within a magnet assembly as described above may include a particular number of HTS tapes in a stack to galvanically connect the joint to the HTS coil in the associated pancake. It may be advantageous when including a closed loop of HTS tapes within the uppermost joint, however, so that a magnetic field of the desired strength is produced through induction of current in the closed loop by an external magnetic field. For example, the joints in the regular pancakes of the magnet assembly may comprise between a stack of between 5 and 30 HTS tapes, such as 10-20 HTS tapes, or around 16 HTS tapes, whereas the joint in the terminal pancake of the magnet assembly may comprise a stack of between 30-50 HTS tapes, such as around 40 HTS tapes.

An illustrative implementation of outer conductive joint 321 is shown in FIG. 3B, including a groove 340 in which a closed loop of superconductor material may be arranged as described above. The shape of the superconductor material that may be arranged in this illustrative joint is shown in FIG. 3C, with the inset of FIG. 3D providing a closer view of the region where the superconductor material 310 overlaps itself to produce a closed loop. The other end of the closed loop may be connected to a power supply for the magnet (e.g., via current leads).

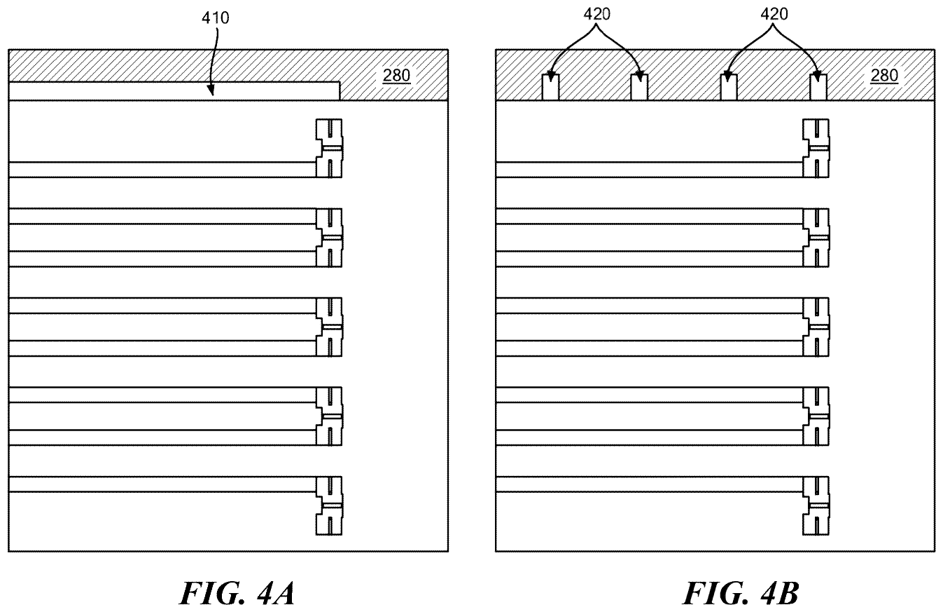

FIGS. 4A-4B depict alternative designs for a magnet assembly that comprises a passive loop of superconductor material, according to some embodiments of a high temperature superconductor magnet. Each of FIGS. 4A and 4B depict the same components as those shown in FIG. 2A and described above, although with differently shaped regions of the tie plate 280 utilized for the passive loop.

In the example of FIG. 4A, a continuous layer of superconductor material 410 is arranged within the tie plate 280. In some embodiments, the continuous layer may comprise a winding of HTS tape without any conventional conductor as a co-wind material, so that the HTS tape forms a continuous layer of HTS.

In the example of FIG. 4B, multiple grooves 420 are arranged in the tie plate 280, each of which may include a closed loop of superconductor material. The example of FIG. 4B is like that of FIG. 2A, except multiple discrete loops are provided in the tie plate, instead of a single loop. As shown, the grooves may be arranged on the same side of the tie plate and have different diameters. In some embodiments, the grooves may be arranged as concentric circles in the tie plate.

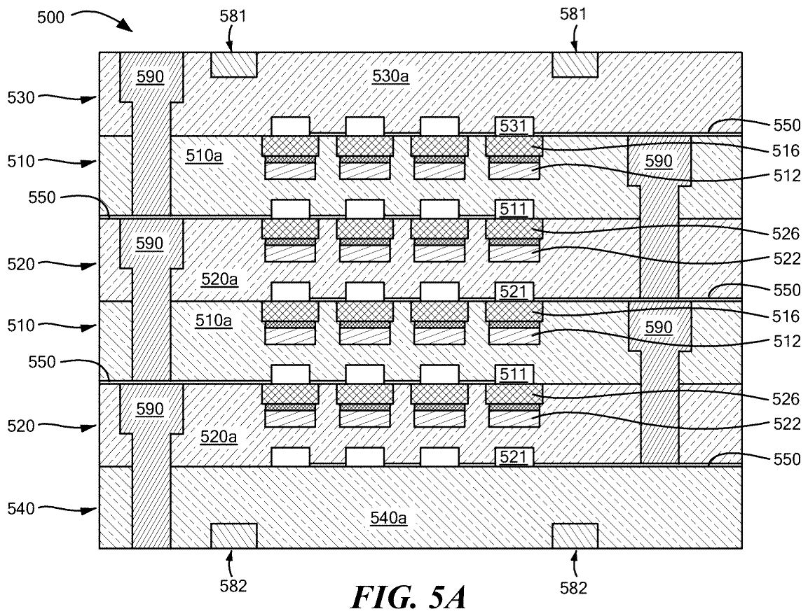

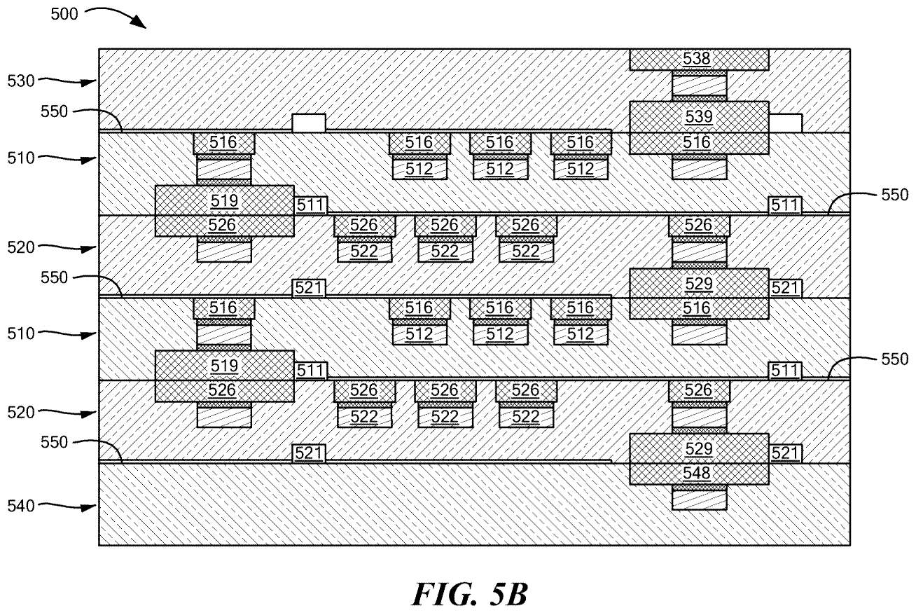

Having described various implementations that provide may provide for shielding of magnet assembly 100 against time-varying external magnetic fields, some illustrative implementations for a different magnet design are described with reference to FIGS. 5A-5B, 6A-6D, and 7A-7C. In particular, a spiral-groove magnet is described that is formed from a stack of plates that each comprise a spiral channel in which a superconductor material is arranged. A passive loop of superconductor material may be added to such a magnet in various implementations, as described below.

FIGS. 5A-5B show different cross-sections of an illustrative stack of plates in a superconducting magnet assembly, according to some embodiments of a high temperature superconductor magnet. Stack of plates 500 comprises two instances of plate 510 and two instances of plate 520, in addition to terminal plates 530 and 540. Layers of insulating material 550 are arranged at selected regions between neighboring plates. FIG. 5A represents a cross-section of the stack of plates through a racetrack portion of the channels of the plates, whereas FIG. 5B represents a cross-section of the stack of plates in the region in which the conducting channels “jog” in or out to switch lanes of the racetrack spiral.

In the example of FIGS. 5A-5B, the conducting channels of plate 510 and 520 include a structural baseplate 510a or 520a, respectively, superconductor material 512 or 522, respectively, and a conductive channel cap 516 or 526, respectively, soldered to the superconductor material. According to some embodiments, the superconductor material 512 and/or 522 may comprise an HTS superconductor, such as HTS tapes, which may be arranged in any desired orientation within the channels of the plates (e.g., stacked radially, that is left to right in FIGS. 5A-5B).

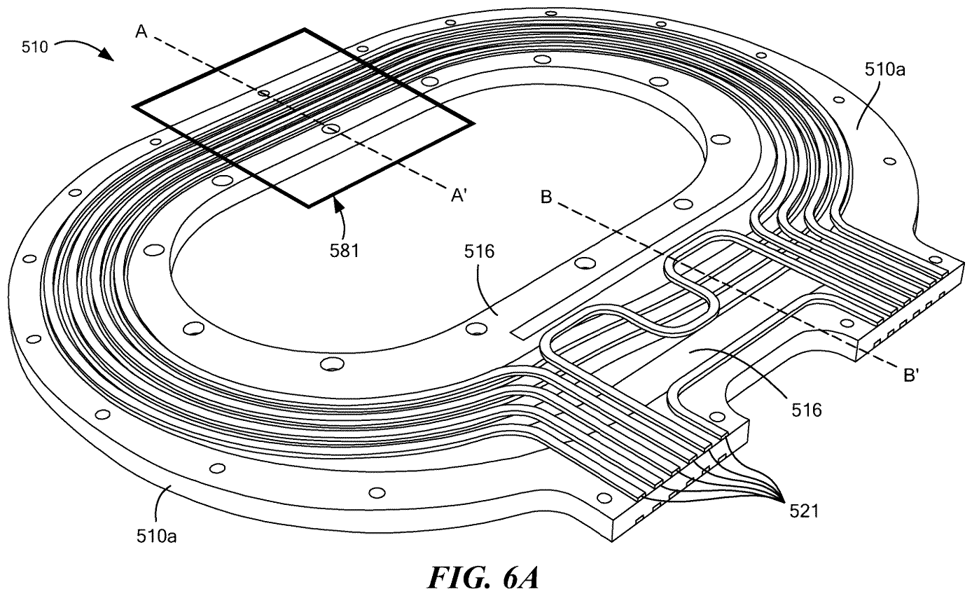

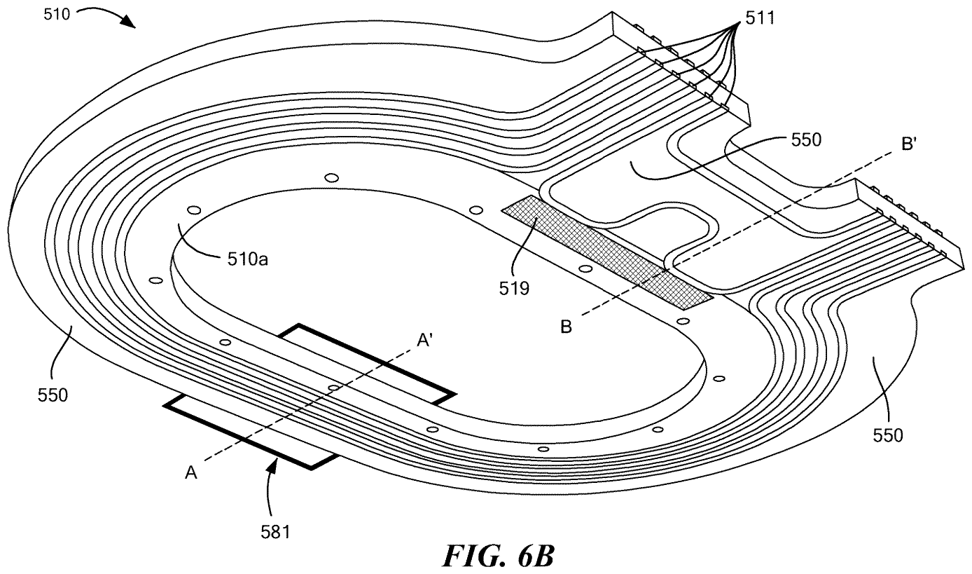

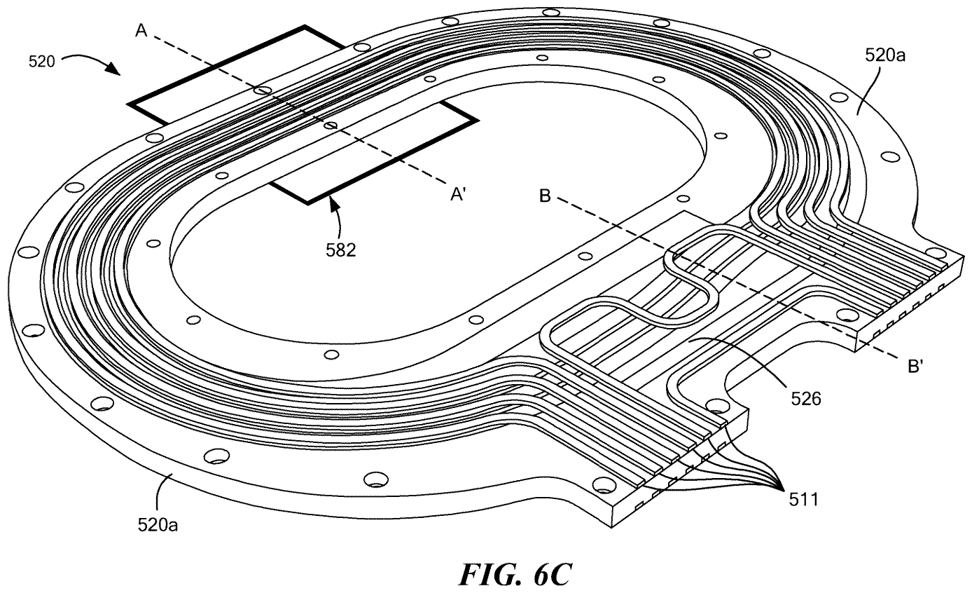

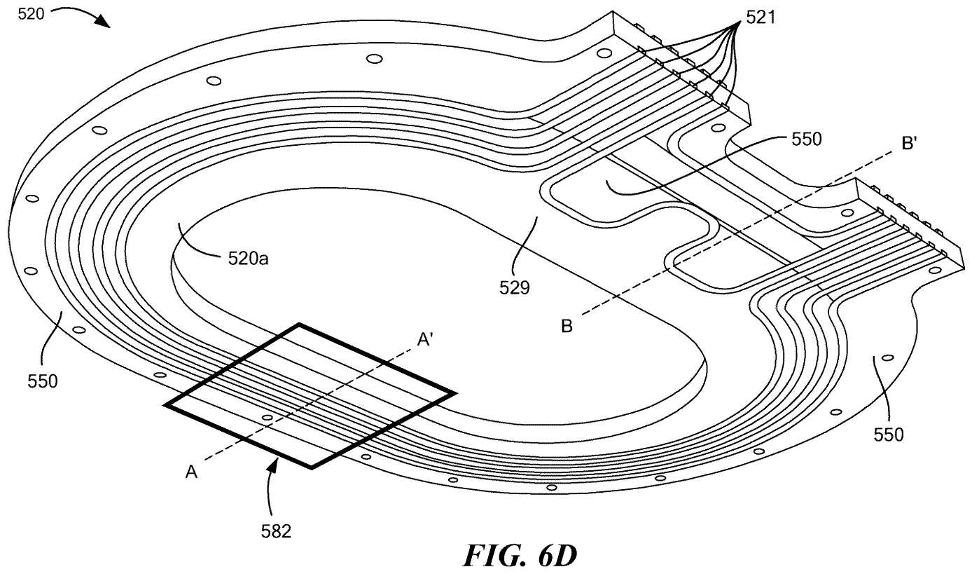

The stack of plates 500 may include two passive loops of superconductor material 581 and 582, which are also shown in FIGS. 6A-6D for the uppermost instance of plate 510 and lowermost instance of plate 520 in stack 500.

In the example of FIGS. 5A-5B, the open cooling channels in one plate may be arranged adjacent to the conducting channel of the neighboring plate. For example, as shown in FIG. 5A, which represents the racetrack portion of the channels, the cooling channels 511 in each instance of plate 510 are arranged adjacent to the cap 526 of the neighboring plate 520. Similarly, the cooling channels 521 in plate 520 are arranged adjacent to the cap 516, and cooling channel 531 is arranged adjacent to the cap 516 in the uppermost instance of the plate 510.

It may be noted that cooling channels 521 in the lowermost instance of plate 520 are not strictly needed since there are no conductors adjacent to these channels. However, due to the modular nature of the plates in the stack 500, it may be more convenient to simply use an instance of plate 520 rather than fabricate a new type of plate that does not include the lowermost cooling channels 521.

In the example of FIGS. 5A-5B, the plates 510, 520, 530 and 540 are held together, at least in part, by bolts 590, which connect neighboring pairs of plates as shown in FIG. 5A. It may be presumed that such bolts are present at several locations around the plates 510, 520, 530 and 540, although the cross-section shown in FIG. 5B does not include any such bolts for clarity.

As shown in FIG. 5B, the plates may include conductive pads to connect the conductive paths in one plate to those of an adjacent plate. For example, the terminal plate 530 includes pad 539 which is adjacent to and electrically connected to the conductive channel cap 516 in the conducting channel of plate 510. Thus, the terminal plate may be adjacent to and electrically connected to one end of the conductive channel of plate 510, the other end of which is electrically connected to the pad 519. Terminal plate 530 also includes pad 538 which may form an external connection from the magnet (e.g., to an external power supply).

Pad 519 is adjacent to and electrically connected to the conductive channel cap 526 in the conducting channel of plate 520. The other end of the cap 526 in the conducting channel of plate 520 is adjacent to and electrically connected to pad 529, which is adjacent to and electrically connected to the next plate 510, and so forth. The bottom plate 540 includes a pad 548 that is adjacent to the lowermost instance of pad 529. In the example of FIG. 5B, the conductive pads 519, 529, 538, 539 and 548 are shaded in the same manner as the caps of the plates, although it will be appreciated that in general the pads and caps need not comprise the same material(s).

According to some embodiments, insulating material 550 may comprise polyimide (e.g., Kapton®), epoxy resin, phenolic resin, glass epoxy laminate, a plastic, an elastomer, or combinations thereof. According to some embodiments, insulating material may have a breakdown voltage or dielectric strength of greater than 25 kV/mm, of greater than 50 kV/mm, of greater than 75 kV/mm, or of greater than 100 kV/mm. In some cases, the voltages in the superconducting magnet may be comparatively low, in which case a low voltage standoff insulating material such as anodized aluminum could be utilized as the insulating material 550.

According to some embodiments, the baseplates 510a, 520a, 530a and 540a may each comprise, or may consist of, a high mechanical strength material such as but not limited to steel, Inconel®, Nitronic® 40, Nitronic® 50, Incoloy®, or combinations thereof. In some embodiments, the baseplates 510a, 520a, 530a and 540a may be plated with a metal such as nickel to facilitate adhesion of other components of the plate, including solder.

In the example of FIG. 5A, bolts 590 are arranged within through holes of the plates 510, 520, 530 and 540 and affix neighboring pairs of plates to one another.

To further illustrate the structure of a stack of plates such as those shown in FIGS. 5A-5B, FIGS. 6A-6D depict upper and lower views of individual plates 510 and 520—specifically, the uppermost plate 510 and the lowermost plate 520.

FIGS. 6A and 6B depict upper and lower views, respectively, of uppermost plate 510, wherein the cross-section of FIG. 5A is through the section marked A-A′ and the cross-section of FIG. 5B is through the section marked B-B′. In the example of FIGS. 6A-6B, the location of cooling channels 521, which are part of plate 520 arranged above the plate 510, are shown for purposes of explanation, although it will be appreciated that these cooling channels are not in fact part of the plate 510. As may be noted, the conducting channel of plate 510 in this example has an inward spiral when following the channel in a clockwise direction viewed from above. FIG. 6B illustrates the underside of plate 510, and includes portions to which insulating material 550 is attached, and portions for which the baseplate 510a is exposed.

As may be seen in FIG. 6A, for the bulk of the racetrack sections of the conducting channel of the plate 510—of which the cap 516 is visible—the cooling channels 521 of the neighboring plate 520 are aligned with the conducting channel. The region of the plate 510 between the coolant inlet and outlet (the two regions where the coolant channels meet the edge of the plate) includes, in the example of FIG. 6A, a “meandering” region of the cooling channel 521 that meanders back and forth over the conducting channels. Various other arrangements may be embodied, including a cooling channel that is aligned with a single conducting channel, but runs back and forth over successive cooling channels in the region between the inlet and outlet.

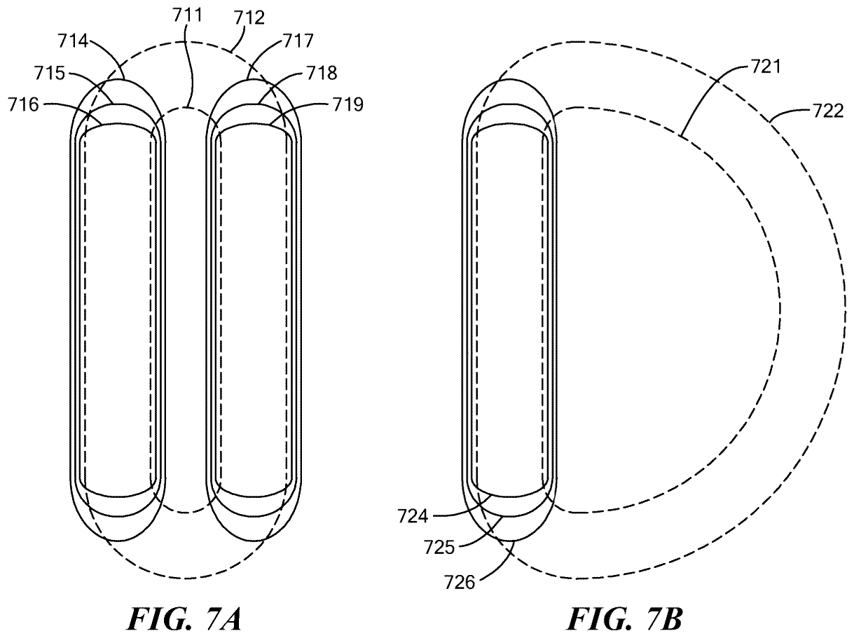

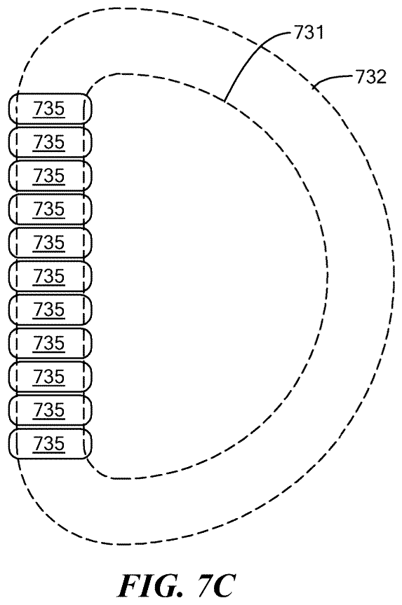

In the example of FIGS. 6A-6B, the passive loop of superconductor material 581 shown in FIG. 5A is depicted above the plate 510. For purposes of illustration, the plate 530a in which the loop is arranged in stack 500 is not shown in FIGS. 6A-6B. This example of a passive loop is one in which the loop is arranged above a straight section of the racetrack coil represented by the superconductor material 512 in the channels of plate 510. The straight sections may be expected to be the most vulnerable to overcurrents, as a result of the self and external fields being the largest in this region. Therefore, it may be preferable to arrange the passive loop proximate to a straight section in a racetrack coil. Other implementations of the passive loop are described below in relation to FIGS. 7A-7C.

In some embodiments, the inlet and outlet regions of the plate may be further apart than is shown in the example of FIG. 6A, such as at opposite ends of the plate from one another. In such cases, the cooling channels may be arranged so that some cooling channels (e.g., half) pass along one side of the plate with the other cooling channels passing along the other side of the plate.

FIGS. 6C and 6D depict upper and lower views, respectively, of plate 520, wherein the cross-section of FIG. 5A is through the section marked A-A′ and the cross-section of FIG. 5B is through the section marked B-B′. In the example of FIGS. 6C-6D, the location of cooling channels 511, which are part of plate 510 arranged above the plate 520, are shown for purposes of explanation, although it will be appreciated that these cooling channels are not in fact part of the plate 520. As may be noted, the conducting channel of plate 520 in this example has an outward spiral when following the channel in a clockwise direction viewed from above. FIG. 6D illustrates the underside of plate 520, and includes portions to which insulating material 550 is attached, and portions for which the baseplate 520a is exposed.

As may be seen in FIG. 6C, for the bulk of the racetrack sections of the conducting channel of the plate 520—of which the cap 526 is visible—the cooling channels 511 of the neighboring plate 510 are aligned with the conducting channel. The region of the plate 520 between the coolant inlet and outlet (the two regions where the coolant channels meet the edge of the plate) includes, in the example of FIG. 6C, a “meandering” region of the cooling channel 511 that meanders back and forth over the conducting channels. Various other arrangements may be embodied, including a cooling channel that is aligned with a single conducting channel, but runs back and forth over successive cooling channels in the region between the inlet and outlet.

In the example of FIGS. 6C-6D, the passive loop of superconductor material 582 shown in FIG. 5A is depicted below the plate 510. For purposes of illustration, the plate 540a in which the loop is arranged in stack 500 is not shown in FIGS. 6C-6D. This example of a passive loop is one in which the loop is arranged below a straight section of the racetrack coil represented by the superconductor material 512 in the channels of plate 520. As described above, the straight sections may be expected to be the most vulnerable to overcurrents.

In some embodiments, the inlet and outlet regions of the plate may be further apart than is shown in the example of FIG. 6C, such as at opposite ends of the plate from one another. In such cases, the cooling channels may be arranged so that some cooling channels (e.g., half) pass along one side of the plate with the other cooling channels passing along the other side of the plate.

FIGS. 7A-7C depict alternative passive loop geometries for magnet coils, according to some embodiments. In each of FIGS. 7A-7C, the inner and outer extent of the coils of a spiral magnet are depicted with dashed lines, and the general shape of a passive loop of superconductor material is represented by a solid line. Each of the passive loops shown in FIGS. 7A-7C and described below may comprise HTS superconductor, such as a stack of HTS tapes, and may form a closed loop of superconductor that is not galvanically connected to the primary current-carrying superconductor of the spiral magnet coils. The passive loops within a given embodiment described below may also be not galvanically coupled to one another.

In the example of FIG. 7A, six passive loops 714-719 are arranged over straight portions of a racetrack coil arranged within the bounds 711 and 712. According to some embodiments, one or more (including all) of the loops 714-719 may be arranged in the same plane (i.e., at the same distance going into or out of the page in the drawing).

The use of multiple passive loops as shown in FIG. 7A may increase the total current induced by a time-varying external magnetic field by providing more available paths for the shielding current to follow.

In the example of FIG. 7B, passive loops 724-726 are arranged over a straight portion of a D-shaped coil arranged within the bounds 721 and 722 in D-shaped channels that include a straight section and a curved section. According to some embodiments, one or more (including all) of the loops 724-726 may be arranged in the same plane (i.e., at the same distance going into or out of the page in the drawing). In a D-shaped coil (such as may be used as a toroidal field magnet in a tokamak), the highest radial currents induced by a time-varying external magnetic field may be expected to occur in the bends at the end of the straight section. The passive loops 724-726 may be advantageous in that they provide a path for current to be induced close to the bends and thereby mitigate this source of overcurrents.

In the example of FIG. 7C, eleven passive loops 735 are arranged over a straight portion of a D-shaped coil arranged within the bounds 731 and 732 in D-shaped channels that include a straight section and a curved section. According to some embodiments, one or more (including all) of the loops 735 may be arranged in the same plane (i.e., at the same distance going into or out of the page in the drawing). It should be appreciated that different embodiments may have different dimensions, and that the number of passive loops 735 depicted in FIG. 7C is merely illustrative of the general principle of arranging passive loops over a straight portion of coil.

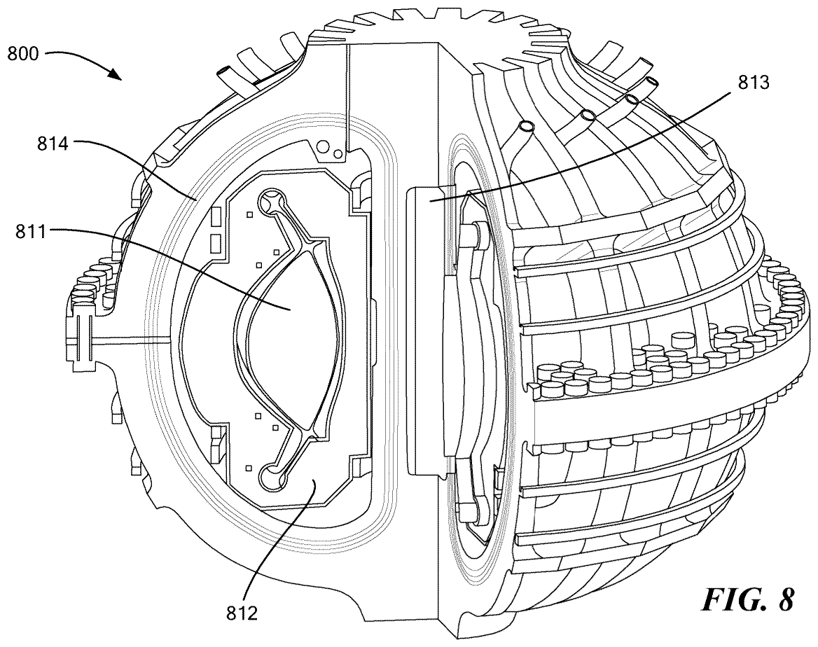

FIG. 8 is a three-dimensional graphic of a fusion machine with a cutaway portion illustrating various components of a tokamak, according to some embodiments. A fusion machine may comprise a magnet, or a magnet assembly, produced as described above. FIG. 8 shows a cross-section through a tokamak 800 and includes a magnet coil 814, a neutron shield 812, and a core region 811. According to some embodiments, the magnet coil 814 may be, or may form part of, a toroidal field coil. In some embodiments, magnet coil 813 may be fabricated from, or otherwise includes, any superconducting magnet or magnet assembly as described above. According to some embodiments, the magnet coil 813 may be, or may form part of a central solenoid and/or other poloidal field solenoidal coils.

Persons having ordinary skill in the art may appreciate other embodiments of the concepts, results, and techniques disclosed herein. It is appreciated that superconducting magnets configured according to the concepts and techniques described herein may be useful for a wide variety of applications. For instance, one such application is conducting nuclear magnetic resonance (NMR) research into, for example, solid state physics, physiology, or proteins. Another application is performing clinical magnetic resonance imaging (MRI) for medical scanning of an organism or a portion thereof, for which compact, high-field magnets are needed. Yet another application is high-field MRI, for which large bore solenoids are required. Still another application is for performing magnetic research in physics, chemistry, and materials science. Further applications are in magnets for particle accelerators for materials processing or interrogation; wind power generators and other electrical power generators; medical accelerators for proton therapy, radiation therapy, and radiation generation generally; superconducting energy storage; magnetohydrodynamic (MHD) electrical generators; and material separation, such as mining, semiconductor fabrication, and recycling. It is appreciated that the above list of applications is not exhaustive, and there are further applications to which the concepts, processes, and techniques disclosed herein may be put without deviating from their scope.

As used herein the phrases “HTS materials,” “HTS superconductor material” or “HTS superconductors” refer to superconducting materials having a critical temperature above 30° K at zero self-field.

Having thus described several aspects of at least one embodiment of this invention, it is to be appreciated that various alterations, modifications, and improvements will readily occur to those skilled in the art. Additional aspects of the present disclosure may include:

Aspect 1. A high temperature superconductor (HTS) magnet comprising: a housing comprising: a coil comprising HTS material; and a closed loop of HTS material not galvanically connected to the coil.

Aspect 2. The magnet of aspect 1, wherein the housing further comprises a first structural plate and a second structural plate, wherein the coil is arranged between the first and second structural plates.

Aspect 3. The magnet of aspect 2, wherein the housing further comprises a tie plate that includes a groove, and wherein the closed loop of HTS material is arranged within the groove.

Aspect 4. The magnet of aspect 3, wherein the housing comprises a stack of pancakes each comprising respective coils of HTS material, and wherein the tie plate is arranged at an end of the stack of pancakes.

Aspect 5. The magnet of aspect 2, wherein the coil comprises turns of HTS tape arranged such that turns of the HTS tape contact a face of the HTS tape in an adjacent turn.

Aspect 6. The magnet of aspect 2, wherein the housing further comprises a first partition arranged to separate a first portion of the coil from a second portion of the coil such that turns of the first portion of the coil are entirely arranged within the first partition and turns of the second portion of the coil are entirely arranged outside of the first partition.

Aspect 7. The magnet of aspect 6, wherein the first structural plate comprises a first circular slot, and wherein the first partition is arranged within the first circular slot.

Aspect 8. The magnet of aspect 1, wherein the housing comprises a first plate, the first plate comprising a channel, at least part of the channel being arranged in a spiral path, wherein the coil is arranged within the channel.

Aspect 9. The magnet of aspect 8, wherein the closed loop of HTS material is arranged over part of the channel of the first plate.

Aspect 10. The magnet of aspect 9, further comprising a second closed loop of HTS material arranged beneath the part of the channel of the first plate.

Aspect 11. The magnet of aspect 9, wherein the channel is a D-shaped channel that includes a straight section and a curved section, and wherein the closed loop of HTS material is arranged over the straight section of the channel.

Aspect 12. The magnet of aspect 1, wherein the coil is arranged as a racetrack spiral.

Aspect 13. The magnet of aspect 1, wherein the housing comprises a stack of plates that each comprise a respective channel and a respective coil comprising HTS material within each channel.

Aspect 14. A high temperature superconductor (HTS) magnet comprising: a stack of pancakes each comprising a coil comprising HTS material; and a terminal pancake at an end of the stack of pancakes comprising a closed loop of HTS material.

Aspect 15. The magnet of aspect 14, wherein the terminal pancake comprises a conductive joint galvanically connected to the coils of the stack of pancakes, and wherein the closed loop of HTS material is arranged in contact with the conductive joint of the terminal pancake.

Aspect 16. The magnet of aspect 15, wherein the terminal pancake comprises a groove and wherein the closed loop of HTS material is arranged within the groove.

Aspect 17. The magnet of aspect 14, wherein each pancake of the stack of pancakes comprises an outer conductive joint comprising HTS material, and wherein the terminal pancake comprises an outer conductive joint, with the closed loop of HTS material disposed within the outer conductive joint of the terminal pancake.

Aspect 18. The magnet of aspect 17, wherein the HTS material within the outer conductive joints of the pancakes are each formed from a first number of HTS tapes, and wherein the closed loop of HTS material within the outer conductive joint of the terminal pancake is formed from a second number of HTS tapes that is greater than the first number of HTS tapes.

Aspect 19. The magnet of aspect 14, wherein the closed loop of HTS material is galvanically connected to the coils of the stack of pancakes.

Aspect 20. The magnet of aspect 14, wherein each pancake of the stack of pancakes comprises a first structural plate and a second structural plate, with the coil of the pancake arranged between the first and second structural plates.

Aspect 21. The magnet of aspect 20, wherein the coil of the pancake comprises turns of HTS tape arranged such that turns of the HTS tape contact a face of the HTS tape in an adjacent turn.

Aspect 22. The magnet of aspect 14, wherein each pancake of the stack of pancakes comprises a first partition arranged to separate a first portion of the coil of the pancake from a second portion of the coil of the pancake.

Aspect 23. The magnet of aspect 22, wherein each pancake of the stack of pancakes comprises a first structural plate comprising a first circular slot, and wherein the first partition of the pancake is arranged within the first circular slot.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

The above-described embodiments of the technology described herein can be implemented in any of numerous ways. Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within +20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within +2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within +5% of making a 90° angle with the second direction in some embodiments, and yet within +2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A high temperature superconductor (HTS) magnet comprising:
a housing comprising:
a coil comprising HTS material; and
a closed loop of HTS material not galvanically connected to the coil.

2. The magnet of claim 1, wherein the housing further comprises a first structural plate and a second structural plate, wherein the coil is arranged between the first and second structural plates.

3. The magnet of claim 2, wherein the housing further comprises a tie plate that includes a groove, and wherein the closed loop of HTS material is arranged within the groove.

4. The magnet of claim 3, wherein the housing comprises a stack of pancakes each comprising respective coils of HTS material, and wherein the tie plate is arranged at an end of the stack of pancakes.

5. The magnet of claim 2, wherein the coil comprises turns of HTS tape arranged such that turns of the HTS tape contact a face of the HTS tape in an adjacent turn.

6. The magnet of claim 2, wherein the housing further comprises a first partition arranged to separate a first portion of the coil from a second portion of the coil such that turns of the first portion of the coil are entirely arranged within the first partition and turns of the second portion of the coil are entirely arranged outside of the first partition.

7. The magnet of claim 6, wherein the first structural plate comprises a first circular slot, and wherein the first partition is arranged within the first circular slot.

8. The magnet of claim 1, wherein the housing comprises a first plate, the first plate comprising a channel, at least part of the channel being arranged in a spiral path, wherein the coil is arranged within the channel.

9. The magnet of claim 8, wherein the closed loop of HTS material is arranged over part of the channel of the first plate.

10. The magnet of claim 9, further comprising a second closed loop of HTS material arranged beneath the part of the channel of the first plate.

11. The magnet of claim 9, wherein the channel is a D-shaped channel that includes a straight section and a curved section, and wherein the closed loop of HTS material is arranged over the straight section of the channel.

12. The magnet of claim 1, wherein the coil is arranged as a racetrack spiral.

13. The magnet of claim 1, wherein the housing comprises a stack of plates that each comprise a respective channel and a respective coil comprising HTS material within each channel.

14. A high temperature superconductor (HTS) magnet comprising:
a stack of pancakes each comprising a coil comprising HTS material; and
a terminal pancake at an end of the stack of pancakes comprising a closed loop of HTS material.

15. The magnet of claim 14, wherein the terminal pancake comprises a conductive joint galvanically connected to the coils of the stack of pancakes, and wherein the closed loop of HTS material is arranged in contact with the conductive joint of the terminal pancake.

16. The magnet of claim 15, wherein the terminal pancake comprises a groove and wherein the closed loop of HTS material is arranged within the groove.

17. The magnet of claim 14, wherein each pancake of the stack of pancakes comprises an outer conductive joint comprising HTS material, and wherein the terminal pancake comprises an outer conductive joint, with the closed loop of HTS material disposed within the outer conductive joint of the terminal pancake.

18. The magnet of claim 17, wherein the HTS material within the outer conductive joints of the pancakes are each formed from a first number of HTS tapes, and wherein the closed loop of HTS material within the outer conductive joint of the terminal pancake is formed from a second number of HTS tapes that is greater than the first number of HTS tapes.

19. The magnet of claim 14, wherein the closed loop of HTS material is galvanically connected to the coils of the stack of pancakes.

20. The magnet of claim 14, wherein each pancake of the stack of pancakes comprises a first structural plate and a second structural plate, with the coil of the pancake arranged between the first and second structural plates.

21. The magnet of claim 20, wherein the coil of the pancake comprises turns of HTS tape arranged such that turns of the HTS tape contact a face of the HTS tape in an adjacent turn.

22. The magnet of claim 14, wherein each pancake of the stack of pancakes comprises a first partition arranged to separate a first portion of the coil of the pancake from a second portion of the coil of the pancake.

23. The magnet of claim 22, wherein each pancake of the stack of pancakes comprises a first structural plate comprising a first circular slot, and wherein the first partition of the pancake is arranged within the first circular slot.
